(19) United States
(12) Patent Application Publication
(10) Pub. No.: US 2022/0311673 A1
(43) Pub. Date: Sep. 29, 2022

(54) Method for Onboarding a Network Function Package in ONAP

(71) Applicant: Qiang ZU, Kirkland (CA)

(72) Inventor: Qiang Zu, Kirkland (CA)

(21) Appl. No.: 17/638,894

(22) PCT Filed: Jul. 20, 2020
(86) PCT No.: PCT/IB2020/056807

§ 371 Date: Feb. 28, 2022

Related U.S. Application Data
(60) Provisional application No. 62/894,321, filed on Aug. 30, 2019.

(51) Int. Cl. H04L 41/122; H04L 67/51; H04W 4/50; H04W 48/18

(52) U.S. Cl. CPC H04L 41/122; H04L 67/51; H04W 4/50; H04W 48/18

(57) ABSTRACT

The disclosure relates to a method, system and non-transitory computer readable media for onboarding a network function package in Open Network Automation Platform (ONAP). The method comprises reading a PNF or VNF package; parsing the PNF or VNF package; extracting additional artifacts marked with a corresponding specific artifact label from the PNF or VNF package; transforming the content of the additional artifacts into a network function descriptor using a service design and creation (SDC) which is able to treat the additional artifacts; and instantiating, using a service orchestrator, a network function based on the network function descriptor.

This non-provisional patent application claims priority based upon the prior U.S. provisional patent application entitled “METHOD FOR ONBOARDING A NETWORK FUNCTION PACKAGE IN ONAP”, application No. 62/894,321, filed Aug. 30, 2019, in the names of QIANG.

### TECHNICAL FIELD

The present disclosure relates to the onboarding procedure for packages in Open Network Automation Platform (ONAP).

### BACKGROUND

ONAP provides a comprehensive platform for real-time, policy-driven orchestration and automation of physical and virtual network functions that enables software, network, information technology (IT), cloud providers and developers to rapidly automate new services and support complete lifecycle management.

By unifying member resources, ONAP accelerates the development of an ecosystem around a globally shared architecture and implementation for network automation.

With the advent of 5G, there is a strong requirement from operators for supporting network slicing in the ONAP architecture.

### SUMMARY

Method and steps are provided herein to allow automatically providing additional physical network function (PNF)/virtual network function (VNF) proprieties during the onboarding procedure.

There is provided a method for onboarding a network function package in Open Network Automation Platform (ONAP). The method comprises reading a PNF or VNF package; parsing the PNF or VNF package; extracting additional artifacts marked with a corresponding specific artifact label from the PNF or VNF package; transforming the content of the additional artifacts into a network function descriptor using a service design and creation (SDC) which is able to treat the additional artifacts; and instantiating, using a service orchestrator, a network function based on the network function descriptor.

There is provided a system for onboarding a network function package in Open Network Automation Platform (ONAP). The system comprises processing circuits and a memory. The memory contains instructions executable by the processing circuits whereby the system is operative to read a PNF or VNF package; parse the PNF or VNF package; extract additional artifacts marked with a corresponding specific artifact label from the PNF or VNF package; transform the content of the additional artifacts into a network function descriptor using a service design and creation (SDC) which is able to treat the additional artifacts; and instantiate, using a service orchestrator, a network function based on the network function descriptor.

There is provided a non-transitory computer readable media having stored thereon instructions for onboarding a network function package in Open Network Automation Platform (ONAP). The instructions comprise reading a PNF or VNF package; parsing the PNF or VNF package; extracting additional artifacts marked with a corresponding specific artifact label from the PNF or VNF package; transforming the content of the additional artifacts into a network function descriptor using a service design and creation (SDC) which is able to treat the additional artifacts; and instantiating, using a service orchestrator, a network function based on the network function descriptor.

The method provided herein present improvements to the way ONAP works and how 5G network slices are supported in ONAP.

### BRIEF DESCRIPTION OF THE DRAWINGS

FIG. 1 a schematic illustration of 5G network slices, with interrelations between different components of the 5G network.

FIG. 2 is a schematic illustration of an ONAP data model to support network slicing in ONAP, extracted from a document entitled ONAP Network Slicing Model from 5G use case team—Borislav Glozman (Amdocs), February 2019, included herein by reference in its entirety.

FIG. 3 is a schematic illustration showing a vendor provided onboarding package which is based on ETSI GS NFV-SOL 001 v2.6.1 (2019-05) Network Functions Virtualisation (NFV) Release 2; Protocols and Data Models; NFV descriptors based on the Topology and Orchestration Specification for Cloud Applications (TOSCA) specification (hereinafter “SOL001”) and ETSI GS NFV-SOL 004 v2.6.1 (2019-04) Network Functions Virtualisation (NFV) Release 2; Protocols and Data Models; VNF Package specification (hereinafter “SOL004”), both included herein by reference in their entirety.

FIG. 4 is a flowchart of an example method for onboarding a network function package in ONAP.

FIG. 5 is a schematic illustration of a virtualization environment in which the different steps, method(s) and apparatus(es) described herein can be deployed.

### DETAILED DESCRIPTION

Various features will now be described with reference to the figures to fully convey the scope of the disclosure to those skilled in the art.

Many aspects will be described in terms of sequences of actions or functions. It should be recognized that according to some aspects, some functions or actions could be performed by specialized circuits, by program instructions being executed by one or more processors, or by a combination of both.

Further, computer readable carrier or carrier wave may contain an appropriate set of computer instructions that would cause a processor to carry out the techniques described herein.

The functions/actions described herein may occur out of the order noted in the sequence of actions or simultaneously. Furthermore, in some illustrations, some blocks, functions or actions may be optional and may or may not be executed; these are generally illustrated with dashed lines.

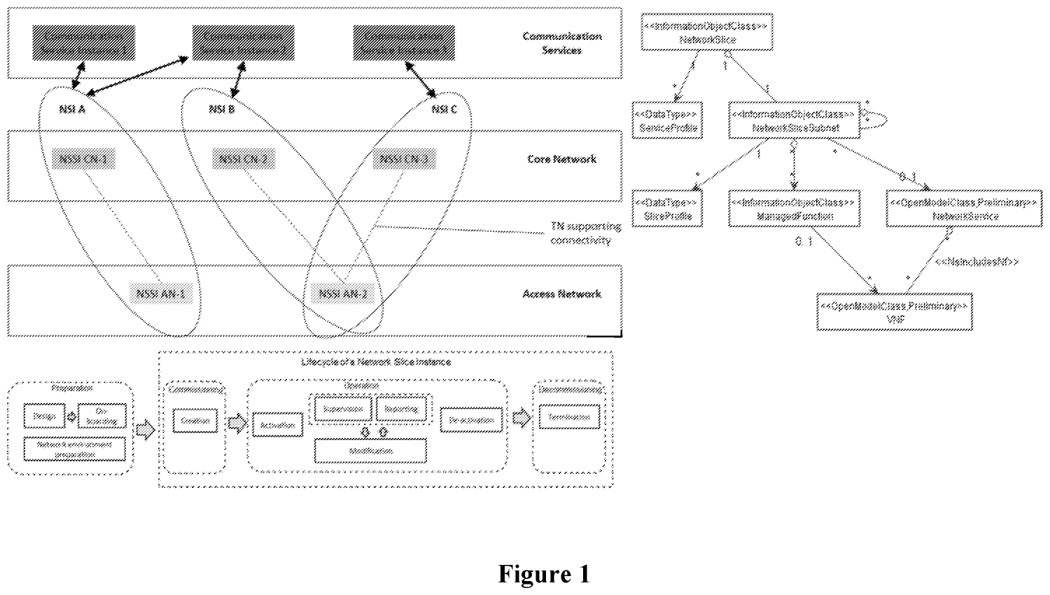

FIG. 1 illustrates 5G network slices, with interrelations between different components of the 5G network. The figure illustrates that a service instance is realized by one or more network slice instances (NSIs), that in turn consist of network slice subnet instance(s) (NSSIs). The lifecycle of a network slice instance is illustrated and corresponds to what is described in 3GPP TR 28.801 Technical Report 3rd Generation Partnership Project; Technical Specification Group Services and System Aspects; Telecommunication management; Study on management and orchestration of network slicing for next generation network.

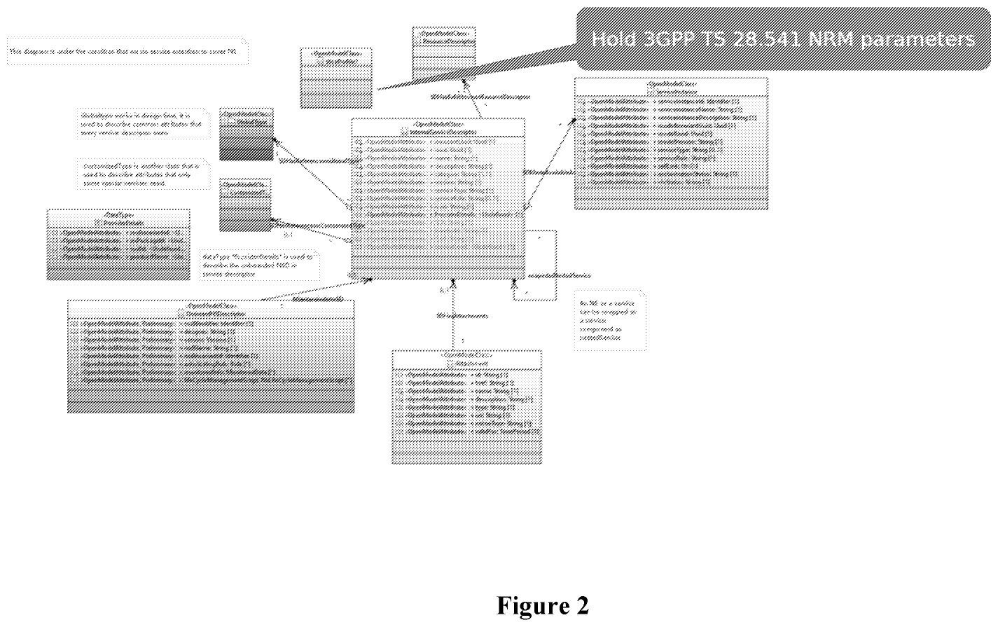

FIG. 2 illustrates a data model, or service descriptor, to support network slicing in ONAP. In the data model of FIG. 2, many additional proprieties need to be provided at design time. Some proprieties are defined at service level, but proprieties that should be provided at resource level are missing. Resource level proprieties should be provided in the onboarding package provided by the vendor to avoid having to do manual steps at onboarding. The new onboarding method provided herein allows to onboard any additional description information into an internal model.

The onboarding procedure consists of taking a provided package, which describes a product of the VNF or PNF, and to input the package in the ONAP system which transforms it into an internal module.

In the provided package there are two different pieces of information: one is called a descriptor, which describes the PNF box or the VNF function(s); and the second piece of information is called artifacts which contains additional information. The artifacts can contain anything, such as: user manual, information, instructions, hyperlinks, data, etc.

Today, when onboarding PNFs, the ETSI standard is followed, in which SOL004 describes what the package should look like and SOL001 describes what the descriptor should look like. In the SOL001 (descriptor) some information is missing, such as the PNF software version, the application configuration data model, as well as many other information. At the time of this disclosure, there were no plans at ETSI to define such additional information, and this caused some problems in the context of PNF life circle management (LCM), for example, but it may also cause problems in the contexts of 5G network slices, service chaining, 5G network service modelling, etc.

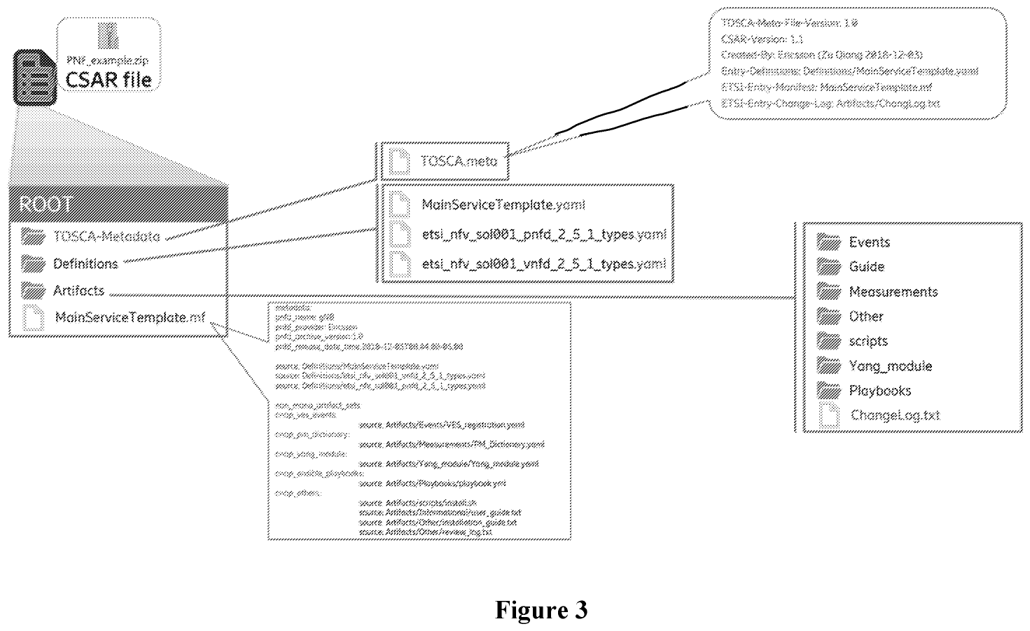

FIG. 3 shows an onboarding package which is based on SOL001 and SOL004. The Cloud Service ARchive (CSAR) file is what is called the package, which is in CSAR format. The CSAR file contains folders, which are illustrated inside the box having the grey header ROOT. It contains TOSCA metadata, definitions, artifacts and a manifest file (in this example MainServiceTemplate.mf). This structure is defined in SOL004. Inside the TOSCA-metadata there is a TOSCA.meta file which has some parameters defined concerning where the rest of the information is located.

Definitions, under ROOT of the CSAR file, comprises the onboarding descriptor of the PNF of this example. It includes a MainServiceTemplate.yam1 (which is a TOSCA name; this file could have a different name). The definitions contain all the parameters of the PNF box. But, as explained previously, there is a lot of missing information there.

The next folder in the CSAR file under ROOT is the artifacts, which contains any additional information that is wanted. Any type of information can be stored there, such as the ChangeLog.txt, different manuals, guides, descriptions, scripts, events, measurements, Yang modules, playbooks, others, etc.

Under the ROOT of the CSAR file is also the manifest file (MainServiceTemplate.mf), which contains the metadata of this PNF package, such as who produces it, its name, how many files are inside. If there is a security key, its location is defined inside this file as well.

One approach to solve the problems stated previously is to define an additional descriptor file and to put it inside the onboarding package. This file can be in JavaScript Object Notation (JSON) or YAML format, to name a few examples. Once the onboarding procedure is launched, a special procedure can be deployed that takes that new piece of information, parses the content and transforms it into the internal descriptor.

The additional information can be added as an artifact under a folder within the package. The location of the additional information artifact file should be defined in the manifest file (the “.mf” file). In this file, there is a section starting with “non_mano_artifact_sets:”, which is a keyword that can be defined in ONAP. Other additional keywords can be defined and included in this file to indicate that something else should be onboarded. All of these can call different processes. For example, the onboarding procedure may not be the same depending on the additional information. For some particular information files, a particular service design and creation (SDC), which is an ONAP process, and more particularly a design phase microservice used at design time, may be needed to get, open, parse and transform the content of the file into the internal descriptor. New SDC process(es) may be defined to treat different files that are added under the artifacts and referenced in the manifest file.

As stated previously, currently, the onboarding package is a description of a network function such as a PNF or a VNF, which are the only two network functions defined by ETSI, and FIG. 3 is an example of such a package as it exists today. In the future, this onboarding package could account for other types of network functions and ETSI is discussing, for example, allocate network function (ANF), which is not finalized yet. In the box in the middle of FIG. 3, i.e. under definitions, are the two files defined today in ETSI: the file etsi_nfv_sol001_pnfd_2_5_1_types.yam1 contains the basic information of the PNF and the file etsi_nfv_sol001_vnfd_2_5_1_types.yam1 contains the information of the VNF. But in the future, there may be more files there. These files are like templates of network functions. The file MainServiceTemplate.yam1 contains a customized description based on these templates.

In the example provided in FIG. 3, the manifest file is in the TOSCA format because TOSCA is quite popular today, but other implementations may be made using the JSON format, eXtensible Markup Language (XML), or other formats. In the example, the first few lines of the manifest file are specific to standard TOSCA format.

As explained previously, the PNF descriptor is specified by network function virtualization (NFV) in the document SOL001. It does not contain all the information which is needed, for example, for network slicing functions.

To cure this deficiency, an additional descriptor can be added in the TOSCA format, as an onboarding artifact inside the onboarding package. In this additional descriptor, any requested slicing related parameters (or parameters needed in other contexts) can be defined. A link can also be included which points to configuration management (CM) Yang model artifacts within the same package. Typically, CM Yang is a model provided for the configuration.

The following is an example of a possible TOSCA format:

```
------------------ example begin ---------------------------------
tosca_definitions_version: tosca_simple_yaml_1_2
description: the additional PNF properties to support network slicing
metadata:
template_name: onap_nf_information_types
template_author: ONAP
template_verion: 1.0
imports:
  - etsi_nfv_sol001_pnfd_types.yaml
node_types:
  onap.node.nfv.pnf
    derived_from: tosca.nodes.nfv.PNF
    artifacts:
      CM_Yang:
        descriptions: CM Yang files
        type: URL
        required: false
    properties:
      sharing_capabilities:
        descriptions: PNF software version
        type: string
        required: false
      latency:
        descriptions: latency in seconds
        type: integrity
        required: false
. . . . . . .
------------------ example end ---------------------------------
```

The first part of the example is TOSCA specific. The additional information starts at “node types” and concerns what was previously missing. Looking at the properties, there is an example of including the PNF software version information, which is missing in the PNF as described by the ETSI standard at the time of this invention. The software version may be a string such as e.g. 1.0 or anything else which is appropriate. Additionally, there can be other properties, such as URL, which provides a link to further content.

In the example above, the format is quite simple compared to YAML, as it is in key pair format. Alternative appropriate formats could be used and there could be more or different properties than those listed in the example depending on the needs.

The parameters of the example should be provided by the vendors in the onboarding packages. The parameters names may have to be agreed as ONAP parameters names, which can be any names selected by ONAP; it should not be vendor specific names.

The additional descriptor provided above as example can be stored in one or more file, but it should be in a specific location of the onboarding package. As explained previously, for instance, it can be added as one of the onboarding artifacts. However, it should have a specific artifact label to allow ONAP to recognize it.

With this, at onboarding, the ONAP design time SDC collects all the artifact files which are marked under a corresponding specific artifact label. Then it reads/parses the additional descriptor information and transform it into the internal information model.

In the context of network slices, this new onboarding method does provide a lot of support. Some slicing information may be needed at onboarding, e.g. slicing capacity, slicing unit, which can be added using the process/steps described herein. Other information may be needed as well, and the changes proposed herein should accommodate different scenarios. However, the slice information model is still under discussion in ONAP and is not finalized yet.

In following steps, based on the onboarding additional parameters, an operator can add any related service level parameters for network slicing. The steps include allowing onboarding additional proprieties using existing onboarding procedure in ONAP. Defining any network slicing characters automatically to avoid too many manual steps at design time. Allowing onboarding any other parameters (needed in the future), in the same way.

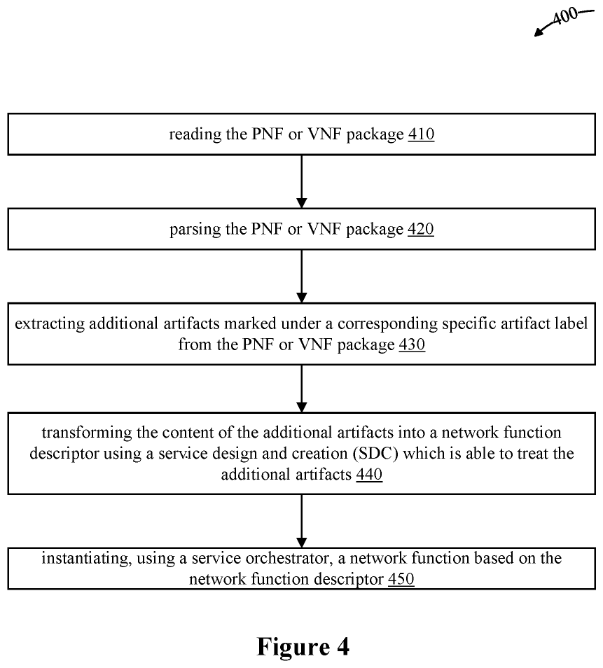

FIG. 4 illustrates a method 400 for onboarding a network function package in ONAP, comprising the steps of: reading, step 410, a PNF or VNF package, parsing, step 420, the PNF or VNF package, extracting, step 430, additional artifacts marked with a corresponding specific artifact label from the PNF or VNF package, transforming, step 440, the content of the additional artifacts into a network function descriptor using a particular service design and creation (SDC) which is able to treat the additional artifacts, and instantiating, step 450, using a service orchestrator, a network function based on the network function descriptor. The SDC may distribute the network function descriptor for use at run time. At run time, the VNF or PNF is instantiated based on the network function descriptor distributed by SDC.

The additional artifacts may comprise PNF or VNF software information, wherein the software information comprises a software version. The additional artifacts may be included in a descriptor file inside the PNF or VNF package. The descriptor file inside the PNF or VNF package may be included under a folder of a folder structure in the PNF or VNF package and a location of descriptor file in the PNF or VNF package may be added to a manifest file inside the PNF or VNF package. The descriptor file may be provided in Topology and Orchestration Specification for Cloud Applications (TOSCA), JavaScript Object Notation (JSON), YAML or eXtensible Markup Language (XML) format. The SDC may be a design phase microservice used at design time. The microservice may get, open, parse and transform the descriptor file inside the PNF or VNF package into the network function descriptor. The additional artifacts may comprise information for defining a network slicing and may comprise slicing parameters, and the content of the additional artifacts may be transformed into a network function slice descriptor. The slicing parameters may comprise slicing capacity and slicing unit.

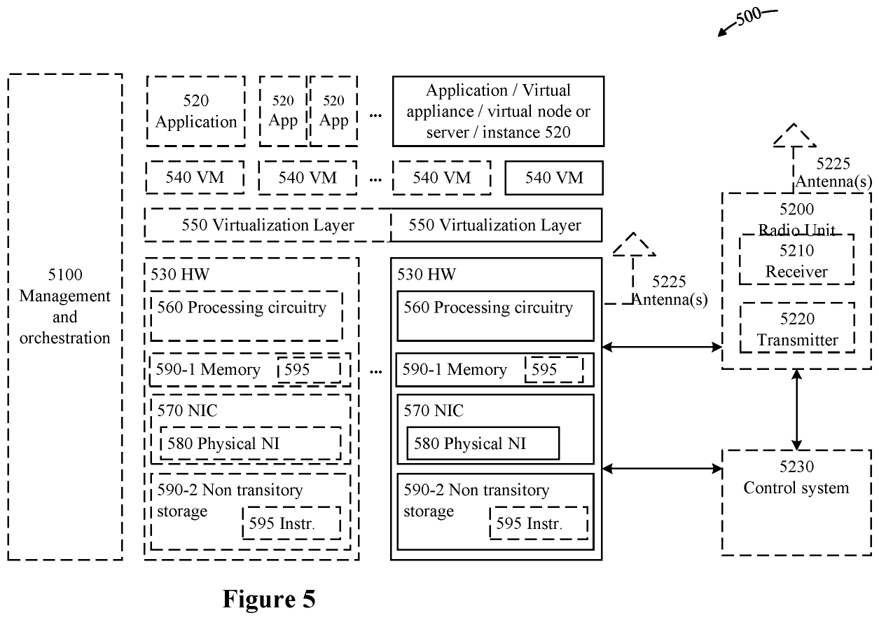

FIG. 5 is a schematic block diagram illustrating a virtualization environment 500 in which some functions may be virtualized.

Applications 520 run in virtualization environment 500 which provides hardware 530 comprising processing circuitry 560 and memory 590. Memory 590 contains instructions 595 executable by processing circuitry 560 whereby application 520 is operative to provide any of the relevant features, benefits, and/or functions disclosed herein.

Virtualization environment 500, comprises general-purpose or special-purpose network hardware devices 530 comprising a set of one or more processors or processing circuitry 560, which may be commercial off-the-shelf (COTS) processors, dedicated Application Specific Integrated Circuits (ASICs), or any other type of processing circuitry including digital or analog hardware components or special purpose processors. Each hardware device may comprise memory 590-1 which may be non-persistent memory for temporarily storing instructions 595 or software executed by the processing circuitry 560. Each hardware devices may comprise one or more network interface controllers 570 (NICs), also known as network interface cards, which include physical network interface 580. Each hardware devices may also include non-transitory, persistent, machine readable storage media 590-2 having stored therein software 595 and/or instruction executable by processing circuitry 560. Software 595 may include any type of software including software for instantiating one or more virtualization layers 550 (also referred to as hypervisors), software to execute virtual machines 540 or containers as well as software allowing to execute functions described herein.

Virtual machines 540 or containers, comprise virtual processing, virtual memory, virtual networking or interface and virtual storage, and may be run by a corresponding virtualization layer 550 or hypervisor. Different instances of virtual appliance 520 may be implemented on one or more of virtual machines 540 or containers, and the implementations may be made in different ways.

During operation, processing circuitry 560 executes software 595 to instantiate the hypervisor or virtualization layer 550, which may sometimes be referred to as a virtual machine monitor (VMM). Virtualization layer 550 may present a virtual operating platform that appears like networking hardware to virtual machine 540 or to a container.

As shown in FIG. 5, hardware 530 may be a standalone network node, with generic or specific components. Hardware 530 may comprise antenna 5225 and may implement some functions via virtualization. Alternatively, hardware 530 may be part of a larger cluster of hardware (e.g. such as in a data center or customer premise equipment (CPE)) where many hardware nodes work together and are managed via management and orchestration (MANO) 5100, which, among others, oversees lifecycle management of applications 520.

Virtualization of the hardware is in some contexts referred to as network function virtualization (NFV). NFV may be used to consolidate many network equipment types onto industry standard high-volume server hardware, physical switches, and physical storage, which can be located in data centers, and customer premise equipment.

In the context of NFV, a virtual machine 540 or container is a software implementation of a physical machine that runs programs as if they were executing on a physical, non-virtualized machine. Each of virtual machines 540 or container, and that part of the hardware 530 that executes that virtual machine, be it hardware dedicated to that virtual machine and/or hardware shared by that virtual machine with others of the virtual machines 540 or containers, forms a separate virtual network elements (VNE).

Still in the context of NFV, Virtual Network Function (VNF) is responsible for handling specific network functions that run in one or more virtual machines 540 or containers on top of hardware networking infrastructure 530 and corresponds to application 520 in FIG. 5.

One or more radio units 5200 that each include one or more transmitters 5220 and one or more receivers 5210 may be coupled to one or more antennas 5225. Radio units 5200 may communicate directly with hardware nodes 530 via one or more appropriate network interfaces and may be used in combination with the virtual components to provide a virtual node with radio capabilities, such as a radio access node or a base station.

Some signaling can be effected with the use of control system 5230 which may alternatively be used for communication between the hardware nodes 530 and the radio units 5200.

The system 500 and/or processing circuitry 560 is operative to execute any of the steps described herein. The system 500 is operative to onboarding a network function package in Open Network Automation Platform (ONAP). The memory 590 of the system contains instructions executable by the processing circuits 560 whereby the system is operative to read a PNF or VNF package; parse the PNF or VNF package; extract additional artifacts marked with a corresponding specific artifact label from the PNF or VNF package; transform the content of the additional artifacts into a network function descriptor using a service design and creation (SDC) which is able to treat the additional artifacts; and instantiate, using a service orchestrator, a network function based on the network function descriptor.

The non-transitory memory 590-2 can comprise instructions to execute any of the steps described herein. The non-transitory computer readable media 590-2 has stored thereon instructions for onboarding a network function package in Open Network Automation Platform (ONAP). The instructions comprise reading a PNF or VNF package; parsing the PNF or VNF package; extracting additional artifacts marked with a corresponding specific artifact label from the PNF or VNF package; transforming the content of the additional artifacts into a network function descriptor using a service design and creation (SDC) which is able to treat the additional artifacts; and instantiating, using a service orchestrator, a network function based on the network function descriptor.

Modifications will come to mind to one skilled in the art having the benefit of the teachings presented in the foregoing description and the associated drawings. Therefore, it is to be understood that modifications, such as specific forms other than those described above, are intended to be included within the scope of this disclosure. The previous description is merely illustrative and should not be considered restrictive in any way. Although specific terms may be employed herein, they are used in a generic and descriptive sense only and not for purposes of limitation.

1.-19. (canceled)

20. A method for onboarding a network function package in Open Network Automation Platform (ONAP), comprising:
reading a physical network function (PNF) or virtual network function (VNF) package;
parsing the PNF or VNF package;
extracting additional artifacts marked with a corresponding specific artifact label from the PNF or VNF package;
transforming the content of the additional artifacts into a network function descriptor using a service design and creation (SDC) which is able to treat the additional artifacts; and
instantiating, using a service orchestrator, a network function based on the network function descriptor.

21. The method of claim 20, wherein the additional artifacts comprise PNF or VNF software information, wherein the software information comprises a software version.

22. The method of claim 21, wherein the additional artifacts are included in a descriptor file inside the PNF or VNF package.

23. The method of claim 22, wherein the descriptor file inside the PNF or VNF package is included under a folder of a folder structure in the PNF or VNF package and wherein a location of descriptor file in the PNF or VNF package is added to a manifest file inside the PNF or VNF package.

24. The method of claim 22, wherein the descriptor file is provided in Topology and Orchestration Specification for Cloud Applications (TOSCA), JavaScript Object Notation (JSON), YAML or eXtensible Markup Language (XML) format.

25. The method of claim 22, wherein the SDC is a design phase microservice used at design time.

26. The method of claim 25, wherein the microservice gets, opens, parses and transforms the descriptor file inside the PNF or VNF package into the network function descriptor.

27. The method of claim 20, wherein the additional artifacts comprise information for defining a network slicing and comprise slicing parameters, and wherein the content of the additional artifacts is transformed into a network function slice descriptor.

28. The method of claim 27, wherein the slicing parameters comprise slicing capacity and slicing unit.

29. A system for onboarding a network function package in Open Network Automation Platform (ONAP) comprising processing circuits and a memory, the memory containing instructions executable by the processing circuits whereby the system is operative to:
read a physical network function (PNF) or virtual network function (VNF) package;
parse the PNF or VNF package;
extract additional artifacts marked with a corresponding specific artifact label from the PNF or VNF package;
transform the content of the additional artifacts into a network function descriptor using a service design and creation (SDC) which is able to treat the additional artifacts; and
instantiate, using a service orchestrator, a network function based on the network function descriptor.

30. The system of claim 29, wherein the additional artifacts comprise a PNF or VNF software version.

31. The system of claim 30, wherein the additional artifacts are included in a descriptor file inside the PNF or VNF package.

32. The system of claim 31, wherein the descriptor file inside the PNF or VNF package is included under a folder of a folder structure in the PNF or VNF package and wherein a location of descriptor file in the PNF or VNF package is added to a manifest file inside the PNF or VNF package.

33. The system of claim 31, wherein the descriptor file is provided in Topology and Orchestration Specification for Cloud Applications (TOSCA), JavaScript Object Notation (JSON), YAML or eXtensible Markup Language (XML) format.

34. The system of claim 31, wherein the SDC is a design phase microservice used at design time.

35. The system of claim 34, wherein the microservice is configured to get, open, parse and transform the descriptor file inside the PNF or VNF package into the network function descriptor.

36. The system of claim 29, wherein the additional artifacts comprise information for defining a network slicing and comprise slicing parameters, and wherein the content of the additional artifacts is transformed into a network function slice descriptor.

37. The system of claim 36, wherein the slicing parameters comprise slicing capacity and slicing unit.

38. A non-transitory computer readable media having stored thereon instructions for onboarding a network function package in Open Network Automation Platform (ONAP), the instructions comprising:
reading a physical network function (PNF) or virtual network function (VNF) package;
parsing the PNF or VNF package;
extracting additional artifacts marked with a corresponding specific artifact label from the PNF or VNF package;
transforming the content of the additional artifacts into a network function descriptor using a service design and creation (SDC) which is able to treat the additional artifacts; and
instantiating, using a service orchestrator, a network function based on the network function descriptor.
